(19) United States
(12) Patent Application Publication
(10) Pub. No.: US 2005/0206808 A1
(43) Pub. Date: Sep. 22, 2005

(54) Displays with shared backlight guide

(75) Inventor: Ilkka Hyytiainen, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/805,680

(22) Filed: Mar. 18, 2004

(51) Int. Cl. G02F 1/1347

(52) U.S. Cl. 349/74

(57) ABSTRACT

The invention relates to a method of preventing a light leakage of environmental light to a first display of an electronic device through a second display of the electronic device. The first display and the second display are arranged on opposite sides of the electronic device, and a single backlight guide is used for providing a backlight to the first display and to the second display. The method comprises determining whether a light leakage protection mode is to be entered. In case it is determined that a light leakage protection mode is to be entered, the second display is caused to present an essentially black screen. The invention relates equally to a corresponding device and to a corresponding software program product.

### FIELD OF THE INVENTION

The invention relates to a method of preventing a light leakage of environmental light to a first display of an electronic device through a second display of said electronic device, which first display is arranged on a first side of said electronic device and which second display is arranged on a second side of said electronic device opposite to said first side, wherein a single backlight guide is used for providing a backlight to said first display and to said second display.

### BACKGROUND OF THE INVENTION

Electronic devices comprising two displays are well known. In particular foldable electronic devices are often equipped with two displays. A foldable electronic device can be for instance a foldable mobile phone, a foldable Personal Digital Assistant (PDA), or a combination of both like the Nokia communicator.

In such a foldable electronic device, a main display is usually arranged on a front side of the device, which is hidden on the inside of the device when the device is closed. In addition, a second display is arranged on the back side of the device. The second display, which is often smaller and cheaper than the main display, is used for providing status information, the identity (ID) of a caller and other similar basic information to the user of the device even while the device is closed.

In most designs, both displays are arranged in a lid portion of the foldable electronic device, more specifically back to back and adjacent to each other in form of a stack. In this case, the total thickness of the lid portion of the foldable electronic device is defined by the total thickness of the two displays.

For illustration, FIG. 1a presents a schematic diagram of a stack of a main Liquid Crystal Display (LCD) 1 and an external small LCD 2, which may be arranged in a lid portion of a foldable electronic device. The main display 1 is depicted to be arranged on top of the external display 2.

The main display 1 comprises from top to bottom a first layer of glass 10, a liquid crystal 11 and a second layer of glass 12. Below the second layer of glass 12, there is a light guide 13 for illuminating the main display 1, the direction of illumination by the light guide 13 being indicated by arrows. The external display 2 comprises from bottom to top a first layer of glass 20, a liquid crystal 21 and a second layer of glass 22. Above the second layer of glass 22, there is a light guide 23 for illuminating the external display 1, the direction of illumination by the light guide 23 being indicated by arrows. The light guide 13 associated to the main display 1 and the light guide 23 associated to the external display 2 are separated from each other by a thin opaque layer 30.

However, the lid portion of a foldable electronic device should be designed as thin as possible, in order to make the electronic device appealing to users.

In a specific arrangement, therefore a common backlight guide is used for both displays. This arrangement is illustrated in FIG. 1b. FIG. 1b is a schematic diagram of an alternative stack of a main LCD 1 and an external small LCD 2, which may be arranged in a lid portion of a foldable electronic device. The main display 1 is depicted again to be arranged on top of the external display 2.

The main display 1 comprises again from top to bottom a first layer of glass 10, a liquid crystal 11 and a second layer of glass 12. The external display 2 comprises again from bottom to top a first layer of glass 20, a liquid crystal 21 and a second layer of glass 22. In between the second layer of glass 12 of the main display 1 and the second layer of glass 22 of the external display 2, however, a common light guide 3 is arranged in stead of two separate light guides 13, 23.

In the arrangement of FIG. 1b, the shared light guide 3 delivers light in both directions, thus illuminating both displays 1, 2 at the same time. The illumination in two directions is indicated by arrows. By using such a shared light guide 3, the total thickness of the display stack can be reduced by the thickness of one light guide, for example by 1 mm as indicated in FIGS. 1a and 1b. Moreover, the material costs might be reduced, as a single light guide is required instead of two.

In some situations, though, such a shared light guide has the disadvantage that environmental light can penetrate through a first one of the displays and further through the light guide into the second one of the displays. This unintended leakage of light may result in an uneven illumination of the second display, especially if the second display is larger than the first display, as in the example depicted in FIG. 1b, or if the second display is in some other way not covered completely by the first device, for example if both displays have an equal size but are not arranged exactly on top of each other.

For illustration, a situation in which a light leakage occurs is depicted in FIG. 2. The same reference signs are used for corresponding components as in FIGS. 1a and 1b. FIG. 2 presents an opened foldable phone 4, which is composed of a main body 40 and a lid portion 41 connected to each other by means of a hinge 42. The hinge 42 also comprises the electrical connections between the main body 40 and the lid portion 41. The foldable phone 4 can be opened and closed by moving the lid portion 41 relative to the main body 40 around the hinge 42 in direction of the double-headed arrow 43. At the front side 44 of the phone 4, which is hidden within the phone 4 when the phone 4 is closed, a main LCD 1 is arranged. At the opposite back side 45 of the phone 4, a smaller external LCD 2 is arranged. In between the main display 1 and the external display 2, a shared light guide 3 is arranged.

An external light source 47, which is located on the back side 45 of the phone 4, emits a bright light indicated by arrows 48. The emitted light penetrates through the external display 2 and the shared light guide 3 into the main display 1, resulting in a small rectangular area on the screen of the main display 1 which is brighter than the rest of the screen. This brighter area is indicated in FIG. 2 by dashed lines 46.

It is to be understood that the same problem may occur in other electronic devices having two displays arranged on opposite sides of the device, not exclusively with foldable electronic devices.

### SUMMARY OF THE INVENTION

It is an object of the invention to prevent an unintended leakage of environmental light in an electronic device with two displays.

A method of preventing a light leakage of environmental light to a first display of an electronic device through a second display of this electronic device is proposed, wherein the first display and the second display are arranged on opposite sides of the electronic device, and wherein a single backlight guide is used for providing a backlight to the first display and to the second display. The proposed method comprises determining whether a light leakage protection mode is to be entered. Moreover, the proposed method comprises causing the second display to present an essentially black screen, in case it is determined that a light leakage protection mode is to be entered.

In addition, an electronic device is proposed, which comprises a first display and a second display, wherein the first display and the second display are arranged on opposite sides of the electronic device. The proposed electronic device further comprises a backlight guide adapted to provide a backlight in common to the first display and to the second display. The proposed device moreover comprises a detection component adapted to determine whether a light leakage protection mode is to be entered. Further, the proposed device comprises a control component adapted to cause the second display to present an essentially black screen in case the detection component detects that a light leakage protection mode is to be entered.

Finally, a software program product is proposed, in which a software code for preventing a light leakage of environmental light to a first display of an electronic device through a second display of this electronic device is stored. The first display and the second display are arranged on opposite sides of the electronic device, and a single backlight guide is used for providing a backlight to the first display and to the second display. When running in a control component of such an electronic device, the software code realizing the steps of the proposed method.

The invention proceeds from the consideration that environmental light will be blocked from entering an electronic device via a display, when the screen of the display is completely black. It is therefore proposed that one of the displays of the electronic device is caused to present an essentially black screen, for instance instead of some information, whenever a light leakage is to be prevented. It has to be noted that the formulation “essentially black screen” comprises beside a black screen alternatively any other very dark screen, for example a very dark gray screen.

It is an advantage of the invention that an uneven illumination on one of the displays is avoided.

The invention can be employed with any electronic device comprising two displays which are arranged such that there is a risk of a light leakage of environmental light through one display to the other display. It can be employed in particular in a foldable electronic device, like a foldable phone or a foldable PDA, as these regularly comprise two displays.

If the invention is implemented in a foldable electronic device, in which the first display is only visible when the foldable electronic device is opened, it may be determined that a light leakage protection mode is to be entered in case it is detected that the foldable electronic device is opened. In case a foldable electronic device is open, the user of the device will usually use exclusively the first display and not the second display anyhow.

It has to be noted, though, that the determination that a light leakage protection mode is to be entered can also be based on various other criteria. It can further be based on a single criterion or on a plurality of criteria. The determination can be based for example alternatively or in addition on a user input indicating that a light protection mode is to be entered or to be exited. Further, the intensity of environmental light hitting the second display could be measured and evaluated. The light protection mode could then be determined to have to be entered only in case the light intensity exceeds a predetermined threshold.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1a is a schematic diagram of a conventional display stack with two displays using separate light guides;

FIG. 1b is a schematic diagram of a conventional display stack with two displays using a shared light guide;

FIG. 2 is a schematic block diagram illustrating the problem of light leakage with the display stack of FIG. 1b;

FIG. 3 is a schematic block diagram of an electronic device according to an embodiment of the invention; and

FIG. 4 is a flow chart illustrating a method implemented in the device of FIG. 3.

### DETAILED DESCRIPTION OF THE INVENTION

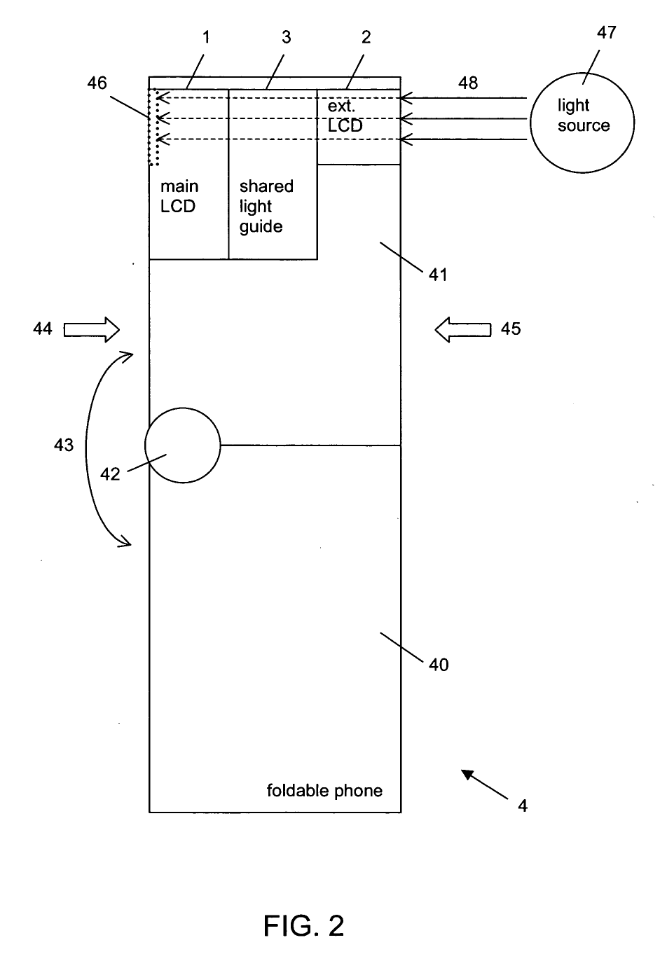

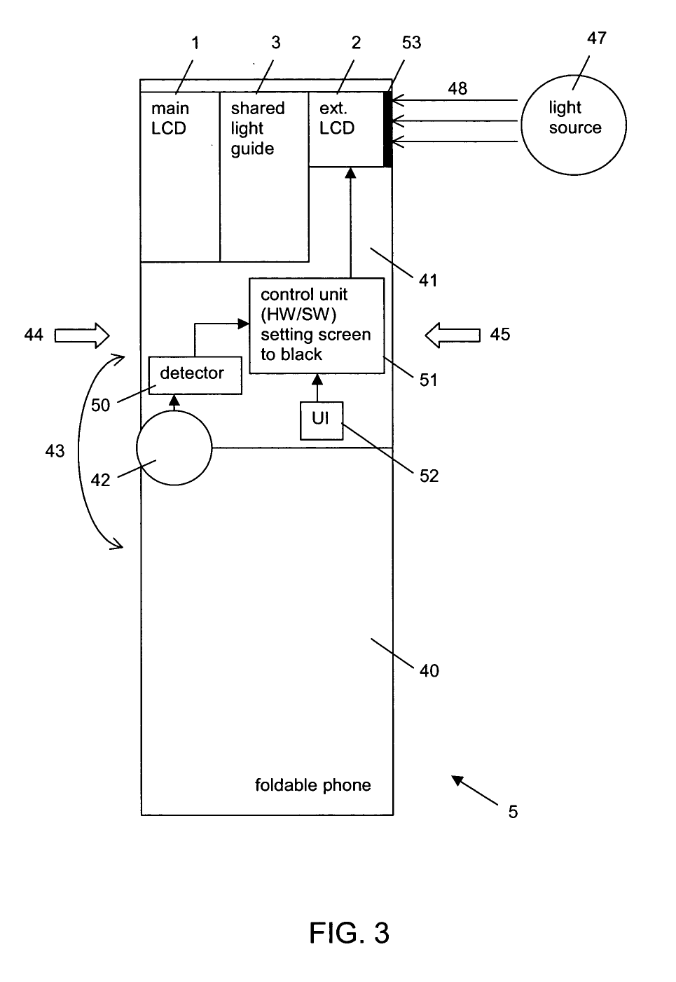

FIG. 3 is a schematic block diagram of a foldable cellular mobile phone 5 as an embodiment of the electronic device according to the invention. The structure of the phone 5 proceeds from the structure of the phone 4 depicted in FIG. 2, and the same reference signs were used for corresponding components.

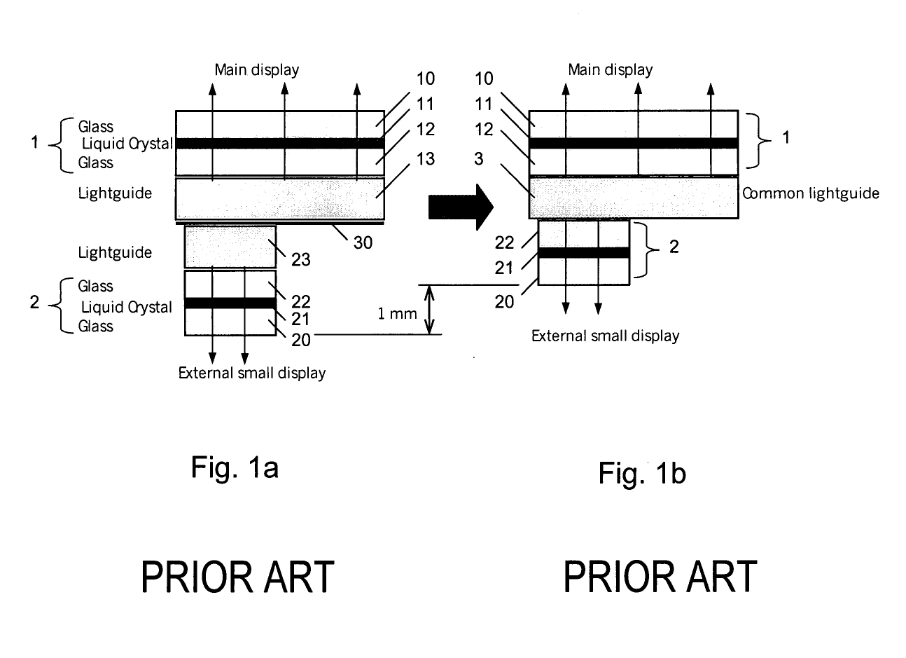

The foldable phone 5, which is presented in FIG. 3 in an opened state, comprises a main body 40 and a lid portion 41 connected to each other by means of a hinge 42. The foldable phone 5 can be opened and closed by moving the lid portion 41 relative to the main body 40 around the hinge 42 in direction of double-headed arrows 43. At the front side 44 of the phone 5, which is hidden within the phone 5 when the phone 5 is closed, a main LCD 1 is arranged. At the opposite back side 45 of the phone 5, a smaller external LCD 2 is arranged. The displays 1, 2 have the same structure as shown in FIG. 1b. In between the main display 1 and the external display 2, a shared light guide 3 is arranged.

Compared to the phone 4 of FIG. 2, the phone 5 of FIG. 3 comprises in addition a detector 50, which is able to detect whether the phone 5 is opened or closed. The detector 50 is connected to a control component 51, which has a controlling access to the external display 2. The control component 51 can be realized by hardware and/or software. Moreover, a user interface 52 is connected to the control component 51. The user interface can be for instance a dedicated button.

Again, a light source 47 emitting a bright light in direction of the phone 5, as indicated by arrows 48, is located on the back side 45 of the phone 5.

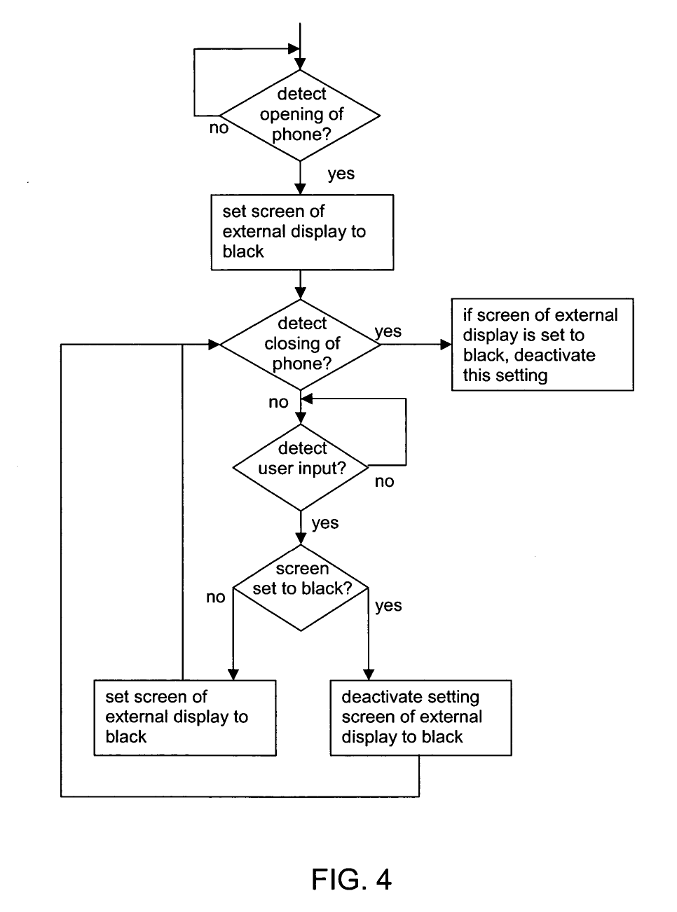

The light leakage protection in the phone 5 will now be explained with reference to the flow chart of FIG. 4.

The flow chart proceeds from a situation in which the phone 5 is closed. In this situation, information can be presented to a user only via the small external display 2.

The detector 50 monitors whether the phone 5 is opened, for example by detecting that an electrical contact in the hinge 42 or at some other place was opened or closed by the movement.

When the detector 50 detects that the phone 5 has been opened, it provides a corresponding indication to the control component 51. The control component 51 thereupon sets the screen of the external display 2 to black. This is indicated in FIG. 3 by a black rectangle 53 in the external display 2. As a result, the light 48 emitted by the light source 47 and reaching the external display 2 is not able to penetrate into the phone 5 and thus to cause a disturbance in the presentation of the main display 1.

Now, the detector 50 now monitors whether the phone 5 is closed again.

If the detector 50 detects that the phone 5 is closed again, it provides a corresponding indication to the control component 51. The control component 51 deactivates thereupon the setting of the screen of the external display 2 to black. The external display 2 can now be used again in a conventional manner.

As long as the detector 50 does not detect that the phone 5 is closed again, the user interface 52 monitors whether there is a user input, for instance, whether the user presses the dedicated button. The user may provide such an input in case he/she desires to use the external display 2 even though the main display could be used as the phone is opened.

In case there is an input via the user interface 52 and the screen of the external display 2 is currently set to black, this setting is deactivated. The external display 2 can now be used again in a conventional manner, even thought the phone 5 is still opened.

In case there is an input via the user interface 52 and the screen of the external display 2 is currently not set to black, the screen of the external display 2 is set to black. This enables the user to enter the light leakage protection mode again if desired after it has been left.

A user interface could also be used alternatively or in addition for activating and deactivating the light leakage protection permanently.

It shall be understood that the presented foldable phone comprises in addition to the described components any components which are known from the state of the art to be employed in mobile phones. Such known components can also be made use of for implementing the invention.

The control component 51 may be for example a control component which is comprised in the phone 5 anyhow for controlling the presentation of information via the external display 2, if this control component is adapted in accordance with the invention to blacken the screen of the external display 2 in response to an indication by the detector 50 and/or the user interface 52.

Moreover, usually, some kind of detector monitoring whether a foldable phone 5 is opened or closed is provided anyhow in a foldable phone, for example in order to allow that an incoming call is accepted automatically when the phone is opened. The detector 50 employed according to the invention may thus correspond to such a known detector, which is adapted to provide the monitoring results in addition to the control component 51.

Further, the user interface 52 could be instead of a dedicated button for example a menu item which can be selected by means of the regular keys of the phone 5.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method of preventing a light leakage of environmental light to a first display of an electronic device through a second display of said electronic device, which first display and which second display are arranged on opposite sides of said electronic device, wherein a single backlight guide is used for providing a backlight to said first display and to said second display, said method comprising:
determining whether a light leakage protection mode is to be entered; and
in case it is determined that a light leakage protection mode is to be entered, causing said second display to present an essentially black screen.

2. The method according to claim 1, wherein said electronic device is a foldable electronic device, wherein said first display is only visible when said foldable electronic device is opened, and wherein it is determined that a light leakage protection mode is to be entered in case it is detected that said foldable electronic device is opened.

3. The method according to claim 1, wherein said determination whether a light leakage protection mode is to be entered is based on a user input.

4. An electronic device comprising:
a first display;
a second display, wherein said first display and said second display are arranged on opposite sides of said electronic device;
a backlight guide adapted to provide a backlight in common to said first display and to said second display;
a detection component adapted to determine whether a light leakage protection mode is to be entered; and
a control component adapted to cause said second display to present an essentially black screen in case said detection component detects that a light leakage protection mode is to be entered.

5. The electronic device according to claim 4, wherein said electronic device is a foldable electronic device, and wherein said first display is only visible when said foldable electronic device is opened.

6. The electronic device according to claim 5, wherein said detection component is adapted to detect whether said foldable electronic device is opened and to determine that a light leakage protection mode is to be entered in case it is detected that said foldable electronic device is opened.

7. The electronic device according to claim 4, wherein said detection component is adapted to determine based on a user input whether a light leakage protection mode is to be entered.

8. A software program product in which a software code for preventing a light leakage of environmental light to a first display of an electronic device through a second display of said electronic device is stored, wherein said first display and said second display are arranged on opposite sides of said electronic device, and wherein a single backlight guide is used for providing a backlight to said first display and to said second display, said software code realizing the following steps when running in a control component of said electronic device:
determining whether a light leakage protection mode 5 is to be entered; and
in case it is determined that a light leakage protection mode is to be entered, causing said second display to present an essentially black screen.
